(19) United States
(12) Patent Application Publication
(10) Pub. No.: US 2025/0340138 A1
(43) Pub. Date: Nov. 6, 2025

(54) SELF-RECHARGE ELECTRIC VEHICLE AND HYPER CHARGING SYSTEM

(71) Applicant: Kandas Conde, Staten Island, NY (US)

(72) Inventor: Kandas Conde, Staten Island, NY (US)

(21) Appl. No.: 18/655,809

(22) Filed: May 6, 2024

(51) Int. Cl. B60L 53/14; B60L 53/10; B60L 53/53

(52) U.S. Cl. CPC B60L 53/14; B60L 53/11; B60L 53/53

(57) ABSTRACT

A battery-recharging device configured for efficient charging. The device includes a plurality of battery charging components configured to receive a current and a plurality of battery cells including a first subset and a second subset. The battery charging components are operatively coupled to the first subset. Each battery cell of the first subset is operatively coupled to one or more battery cells of the second subset such that every battery cell of the second subset is operatively coupled to at least one battery cell of the first subset. The battery charging components may deliver the current to the first subset. The first subset may distribute the current to the second subset such that the current is evenly distributed throughout the plurality of battery cells. The device may also include one or more voltage supply lines configured to deliver the current to one or more second external sources.

### FIELD OF THE INVENTION

The present invention is directed to electric vehicles and electric vehicle systems with a continuous hypercharging system.

### BACKGROUND OF THE INVENTION

Electric vehicles allow for a method of transportation with minimized emissions when compared to vehicles that use fossil fuels. However, current electric vehicles need to be plugged into a charging station to recharge the batteries, as said batteries use more energy than what can be recharged through normal use of the vehicle. Other electric vehicles are hybrid systems that implement a combination of electric power and gas power, which still produce carbon emissions. Electric vehicles are configured to stall their battery systems entirely while idling to maintain power, but this is still unable to allow for efficient recharging of the vehicle without the use of external charging components. Thus, there exists a present need for an electric vehicle charging system capable of continuously and efficiently charging batteries during regular use.

### BRIEF SUMMARY OF THE INVENTION

It is an objective of the present invention to provide systems and devices that allow for electric vehicles and electric vehicle systems with a continuous hyper-charging system, as specified in the independent claims. Embodiments of the invention are given in the dependent claims. Embodiments of the present invention can be freely combined with each other if they are not mutually exclusive.

The present invention comprises an electric vehicle that can perform by continuously and/or perpetually recharging the electric vehicle batteries and the main (or high) power battery system by both direct charging and indirect (or reverse) charging at the same time, resulting in an increase of the main battery power. This may eliminate the need for an external power source to recharge the electric vehicle systems while the electric vehicle system is functioning. Therefore, this electric vehicle has a 100% zero carbon footprint unlike other electric vehicles and non-electric (combustion) vehicles.

The present invention features a battery-recharging device configured for efficient charging. In some embodiments, the device may comprise a plurality of battery charging components configured to receive a current from one or more first external sources. The device may further comprise a plurality of battery cells comprising a first subset of battery cells and a second subset of battery cells. The plurality of battery charging components are operatively coupled to the first subset. The first subset and the second subset may be interstitially disposed in an array. Each battery cell of the first subset is operatively coupled to one or more battery cells of the second subset such that every battery cell of the second subset is operatively coupled to at least one battery cell of the first subset. The plurality of battery charging components may be further configured to deliver the current to the first subset. Each battery cell of the first subset may be configured to distribute the current to the one or more battery cells of the second subset operatively coupled to each battery cell of the first subset, such that the current is evenly distributed throughout the plurality of battery cells. The device may further comprise one or more voltage supply lines operatively coupled to at least one of the plurality of battery charging components, at least one of the plurality of battery cells, or a combination thereof, configured to deliver the current from the at least one of the plurality of battery charging components, the at least one of the plurality of battery cells, or the combination thereof to one or more second external sources.

One of the unique and inventive technical features of the present invention is the implementation of an injection charging system driven by parallel charging lines running to and from multiple batteries and alternators. Without wishing to limit the invention to any theory or mechanism, it is believed that the technical feature of the present invention advantageously provides for a continuously hyper-charging electric vehicle system capable of powering the vehicle without the need for a charging station. The parallel lines allow for decreased charging time and increased efficiency. The charging system runs while the car is active, even while idling to constantly generate energy. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a perspective view of the electric vehicle system of the present invention.

FIG. 2 shows a schematic view of the continuous battery hypercharging system of the present invention.

FIG. 3 shows a perspective view of the solar panel boost charger system of the present invention.

FIG. 4 shows a perspective view of the independent electrical vehicle parallel hyper-charging station of the present invention.

### DETAILED DESCRIPTION OF THE INVENTION

Following is a list of elements corresponding to a particular element referred to herein:
100 system switch
102 system switch key
104 fuse box
106 first solenoid
108 second solenoid
110 accelerator pedal
112 accelerator pedal cable
114 accelerator pedal connector
116 idling and accelerator command box
118 motor controller
120 electric motor
122 first battery
124 second battery
126 radiator and fan
128 radiator and fan water pump
130 water hoses
132 air conditioning condenser
134 air conditioning condenser hoses
136 electric motor coupling plate
138 electric motor system shaft
140 main shaft pulley
142 power steering component
144 power steering pulley
146 air conditioning compressor
148 air conditioning compressor pulley
150 distribution belt
152 first alternator
154 first alternator pulley
156 second alternator
158 second alternator pulley
160 belt tensioner
162 belt tensioner pulley
164 fuse box power supply lines
166 first battery charging line
168 second battery charging line
170 vehicle frame ground
172 driving mode command box
174 alternators power supply lines
176 accessories power supply lines
178 idling and accelerator command box power supply line
180 main battery charging lines
182 high voltage supply line
184 electric motor UVW power lines
186 electric motor sensor wire harness
188 motor controller and idling and accelerator command box wire harness
200 automatic transmission
202 shaft bearing
204 shaft bearing mount
206 automatic transmission coupling plate
208 first DC-DC power supply line
210 second DC-DC power supply line
212 DC-DC battery charger power supply line bridge switch box
214 solar panel connector A boost charger
216 solar panel connector B boost charger
218 charge controller
220 solar panel
222 first DC-DC battery charger power supply line fuse
224 second DC-DC battery charger power supply line fuse
230 electric vehicle hyper-charging station
232 electric vehicle hyper-charging station connector A
234 electric vehicle hyper-charging station connector B
240 main battery
242 main battery solenoid
244 main battery solenoid ON/OFF switch
246 main battery high-voltage circuit breaker
248 resistance
250 main battery fuse
252 first DC-DC battery charger
254 second DC-DC battery charger
256 third DC-DC battery charger
258 fourth DC-DC battery charger
262 fifth DC-DC battery charger
264 sixth DC-DC battery charger
266 seventh DC-DC battery charger
268 eighth DC-DC battery charger
270 first battery set
272 second battery set
274 third battery set
276 fourth battery set
278 fifth battery set
280 sixth battery set
282 seventh battery set
284 eighth battery set
286 ninth battery set
288 tenth battery set
290 eleventh battery set
292 twelfth battery set
294 thirteenth battery set
296 fourteenth battery set
298 fifteenth battery set
300 sixteenth battery set
302 first DC-DC battery charger output wire to tenth battery set
304 second DC-DC battery charger output wire to second battery set
306 third DC-DC battery charger output wire to sixth battery set
308 fourth DC-DC battery charger output wire to fourteenth battery set
310 fifth DC-DC battery charger output wire to sixteenth battery set
312 sixth DC-DC battery charger output wire to eighth battery set
314 seventh DC-DC battery charger output wire to twelfth battery set
316 eighth DC-DC battery charger output wire to fourth battery set
400 battery charging components
410 battery cells
420 voltage supply lines
1721 normal driving mode
1722 automatic driving mode

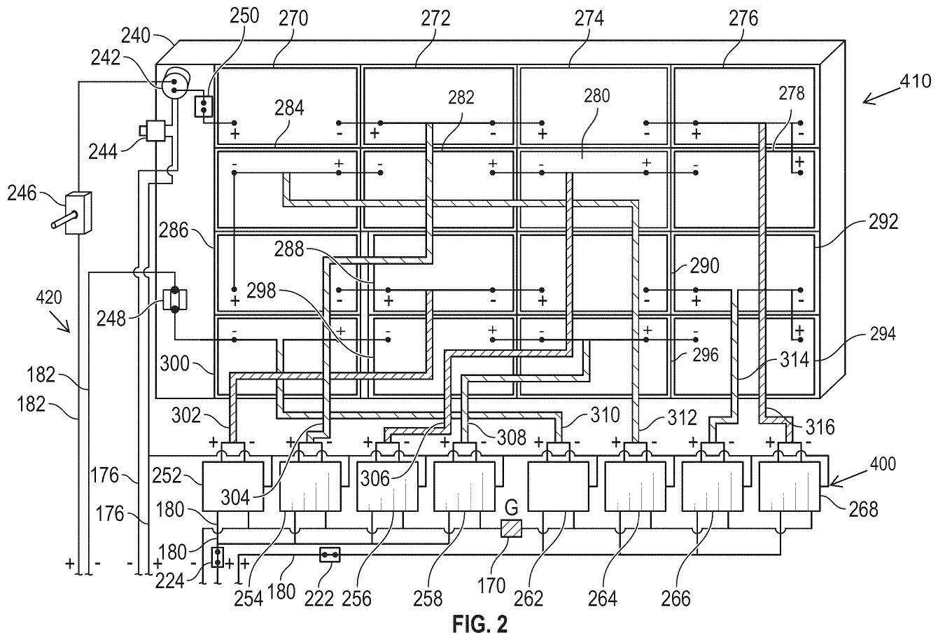

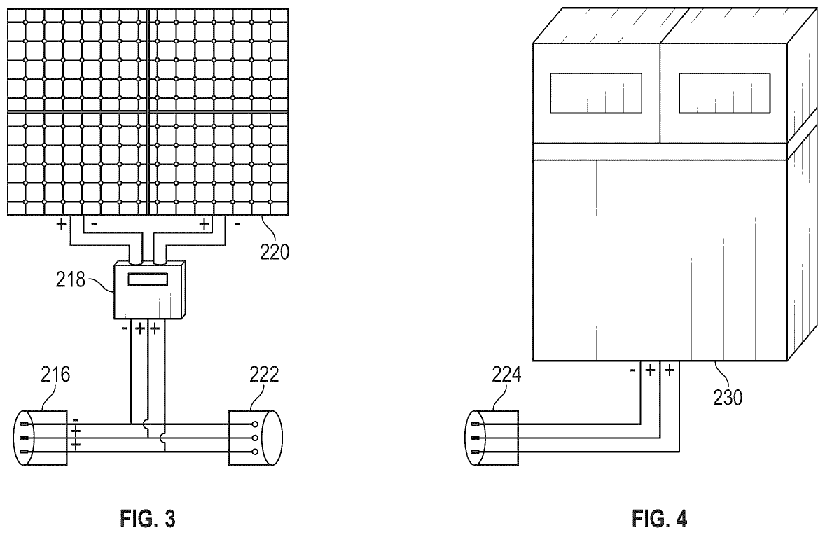

Referring now to FIG. 2, the present invention features a battery recharging device configured for efficient charging. In some embodiments, the device may comprise a plurality of battery charging components (400) configured to receive a current from one or more first external sources. The device may further comprise a plurality of battery cells (410) comprising a first subset of battery cells and a second subset of battery cells. The plurality of battery charging components (400) are operatively coupled to the first subset. In some embodiments, the first subset and the second subset may be interstitially disposed in an array. In some embodiments, each battery cell of the first subset is operatively coupled to one or more battery cells of the second subset such that every battery cell of the second subset is operatively coupled to at least one battery cell of the first subset. In some embodiments, the plurality of battery charging components (400) may be further configured to deliver the current to the first subset. In some embodiments, each battery cell of the first subset may be configured to distribute the current to the one or more battery cells of the second subset operatively coupled to each battery cell of the first subset, such that the current is evenly distributed throughout the plurality of battery cells (410). The device may further comprise one or more voltage supply lines (420) operatively coupled to at least one of the plurality of battery charging components (400), at least one of the plurality of battery cells (410), or a combination thereof, configured to deliver the current from the at least one of the plurality of battery charging components (400), the at least one of the plurality of battery cells (410), or the combination thereof to one or more second external sources.

In some embodiments, the one or more first external sources may comprise one or more batteries, one or more alternators, a solar panel (220), a charging station (230), or a combination thereof. In some embodiments, the one or more second external sources may comprise one or more batteries.

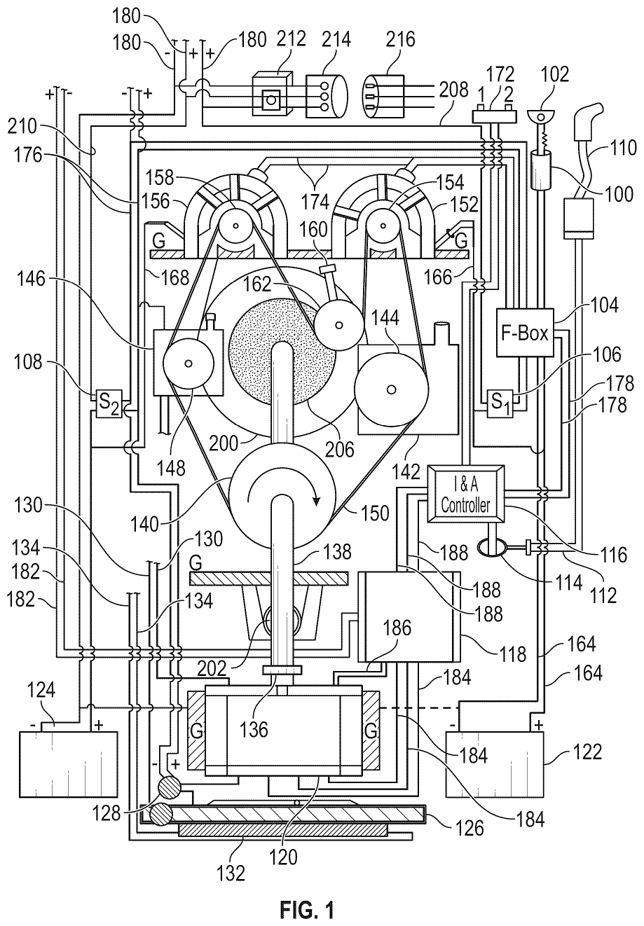

Referring now to FIG. 1, the present invention comprises an electric power control system for efficient charging of batteries. In some embodiments, the system may comprise one or more main batteries, each main battery configured to accept, store, and transmit a current. The system may further comprise a rotating component configured to generate rotational motion. The system may further comprise one or more alternators operatively coupled to the one or more main batteries and the rotating component, configured to accept the rotational motion from the rotating component, generate the current, and direct the current to the one or more main batteries.

The system may further comprise a battery recharging device operatively coupled to the one or more main batteries, configured for efficient charging. In some embodiments, the battery recharging device may comprise a plurality of battery charging components (400) configured to receive a current from one or more first external sources. The device may further comprise a plurality of battery cells (410) comprising a first subset of battery cells and a second subset of battery cells. The plurality of battery charging components (400) is operatively coupled to the first subset. In some embodiments, the first subset and the second subset may be interstitially disposed in an array. In some embodiments, each battery cell of the first subset is operatively coupled to one or more battery cells of the second subset such that every battery cell of the second subset is operatively coupled to at least one battery cell of the first subset. In some embodiments, the plurality of battery charging components (400) may be further configured to deliver the current to the first subset. In some embodiments, each battery cell of the first subset may be configured to distribute the current to the one or more battery cells of the second subset operatively coupled to the battery cell of the first subset, such that the current is evenly distributed throughout the plurality of battery cells (410). The device may further comprise one or more voltage supply lines (420) operatively coupled to at least one of the plurality of battery charging components (400), at least one of the plurality of battery cells (410), or a combination thereof, configured to deliver the current from the at least one of the plurality of battery charging components (400), the at least one of the plurality of battery cells (410), or the combination thereof to one or more second external sources.

In some embodiments, the rotating component may comprise an electric motor (120). In some embodiments, the electric motor (120) may be configured to be powered by the one or more main batteries. In some embodiments, the one or more main batteries may be configured to distribute the current to the electric motor (120), the plurality of battery charging components (400), or a combination thereof by a fuse box (104). In some embodiments, the system may further comprise one or more solenoids disposed electrically in-line with the fuse box (104) and the electric motor (120), configured to convert the current into rotational energy to actuate the alternators. In some embodiments, the electric motor (120) may be further configured to operate an automatic transmission component (200) configured to convert the rotational motion of the electric motor (120) into movement. In some embodiments, the rotating component may be configured to transfer the rotational motion to the one or more alternators by a distribution belt (150). In some embodiments, the system may be configured to be integrated into an electric vehicle. In some embodiments, the one or more main batteries may be further configured to be charged by a solar panel (220), a charging station (230), or a combination thereof.

Referring now to FIG. 1, the present invention features a charging system for an electric vehicle. The system may comprise one or more main batteries, each main battery configured to accept, store, and transmit a current upon actuation. The system may further comprise a fuse box (104) operatively coupled to the one or more main batteries, configured to distribute the current to the electric motor (120). The system may further comprise a system switch component (100), configured to accept a key (102) and actuate the one or more main batteries upon accepting the key (102). The system may further comprise an electric motor (120) operatively coupled to the fuse box (104) and the main battery (240), configured to generate rotational motion upon receiving the current from the fuse box (104) and the main battery (240). The system may further comprise an automatic transmission component (200) operatively coupled to the electric motor (120), configured to convert the rotational motion of the electric motor (120) into movement of the electric vehicle. The system may further comprise an acceleration pedal (110) operatively coupled to the electric motor (120), configured to control an amount of the rotational motion converted by the automatic transmission component (200) into the movement of the electric vehicle. The system may further comprise one or more alternators operatively coupled to the one or more main batteries and the electric motor (120), configured to accept the rotational motion from the rotating component by a distribution belt (150), generate the current, and direct the current to the one or more main batteries.

The system may further comprise a battery recharging device operatively coupled to the one or more main batteries, configured for efficient charging. In some embodiments, the battery recharging device may comprise a plurality of battery charging components (400) configured to receive a current from one or more first external sources. The device may further comprise a plurality of battery cells (410) comprising a first subset of battery cells and a second subset of battery cells. The plurality of battery charging components (400) is operatively coupled to the first subset. In some embodiments, the first subset and the second subset may be interstitially disposed in an array. In some embodiments, each battery cell of the first subset is operatively coupled to one or more battery cells of the second subset such that every battery cell of the second subset is operatively coupled to at least one battery cell of the first subset. In some embodiments, the plurality of battery charging components (400) may be further configured to deliver the current to the first subset. In some embodiments, each battery cell of the first subset may be configured to distribute the current to the one or more battery cells of the second subset operatively coupled to the battery cell of the first subset, such that the current is evenly distributed throughout the plurality of battery cells (410). The device may further comprise one or more voltage supply lines (420) operatively coupled to at least one of the plurality of battery charging components (400), at least one of the plurality of battery cells (410), or a combination thereof, configured to deliver the current from the at least one of the plurality of battery charging components (400), the at least one of the plurality of battery cells (410), or the combination thereof to the electric motor (120).

In some embodiments, the one or more main batteries may be further configured to be charged by a solar panel (220), a charging station (230), or a combination thereof. In some embodiments, the system may further comprise an idling and acceleration controller box (116) operatively coupled to the acceleration pedal (110) and the electric motor (120), configured to convert a pressure applied to the acceleration pedal (110) into a signal. In some embodiments, the system may further comprise a motor controller box (118) operatively coupled to the electric motor (120) and the idling and acceleration controller box (116), configured to operate the electric motor (120) based on the signal. In some embodiments, the electric motor (120) may be operatively coupled to the automatic transmission component (200) by a shaft component (138). In some embodiments, the shaft component (138) may be operatively coupled to the electric motor (120) by a shaft coupling plate (136).

In some embodiments, the first subset of battery cells and the second subset of battery cells may be interstitially disposed in an array. In some embodiments, the first subset and the second subset may be arranged such that a battery cell from the first subset is adjacent to at least one battery cell from the second subset. In some embodiments, the first subset and the second subset may be arranged in an alternating pattern comprising a cell from the first subset, a cell from the second subset, another cell from the first subset, another cell from the second subset, and so on. In some embodiments, the first subset and the second subset may be arranged in a one-dimensional array, a two-dimensional array, or any other formation.

In some embodiments, the plurality of battery charging components may comprise 4 to 12 battery charging components. In some embodiments, the plurality of battery cells may comprise 4 to 32 cells. In some embodiments, the first subset of battery cells may comprise 2 to 16 cells. In some embodiments, the second subset of battery cells may comprise 2 to 16 cells. In some embodiments, the number of cells in the first subset may be equal to the number of cells in the second subset. In some embodiments, the first subset may comprise at least one cell. In some embodiments, the second subset may comprise at least one cell.

In some embodiments, the one or more main batteries may comprise 1 to 4 batteries. In some embodiments, the one or more alternators may comprise 1 to 4 alternators. As a non-limiting example, the number of main batteries may be equal to the number of alternators such that one battery is coupled to one alternator. In other non-limiting embodiments, at least one alternator may be coupled to each battery. In other non-limiting embodiments, at least one battery may be coupled to each alternator.

In some embodiments, the battery charging components may comprise additional batteries, wires, generators, alternators, \DC-DC battery chargers, or a combination thereof. In some embodiments, the rotating component may comprise any motor (e.g. electric), any rotor transferring a rotational motion from another source (e.g. a pulley, a motor, another rotor, a wheel of a car), or a combination thereof. In some embodiments, the automatic transmission component may comprise a gearbox comprising a plurality of gears, configured to modulate rotational motion (e.g. changing rotation direction, increasing power, transferring to another component). In some embodiments, the shaft component may comprise any component, such as but not limited to a rod, defining an axis upon which components coupled to the shaft component may rotate. In some embodiments, the shaft component may rotate to actuate rotation of components coupled to the shaft component. In other embodiments, the shaft component may be stable such that components coupled to the shaft component are able to freely rotate on the shaft component.

In the present invention, the electric power activation, control, and distribution system comprises a system switch (100) with a removable system switch key (102) electrically connected to the battery (122) via a fuse box (104). In the present invention, upon activation of the system switch key (102) to the ON position, the entire electric vehicle system is activated through the accessories power supply line (176), and the electric motor system is idling and running in a normal driving mode (1721).

In some embodiments, the electric power activation, control, and distribution system comprises a first solenoid (106) and a second solenoid (108) which are electrically connected to the fuse box (104) via the accessories power supply line (176). In the present invention, when the system switch key (102) is turned ON, the first solenoid (106) turns on the first DC-DC charging line (208) and the second solenoid (108) turns on the second DC-DC charging line (210).

In some embodiments, the electric power activation, control, and distribution system comprises an accelerator pedal (110) operatively connected to the idling and accelerator command box (116) via the accelerator pedal cable (112). In some embodiments, the electric power activation, control, and distribution system comprises an idling and accelerator command box (116) electrically connecting to the fuse box (104), the driving mode command box (172), and the motor controller (118).

In some embodiments, the electric power activation, control, and distribution system may comprise a motor controller (118) electrically connected to the main battery (240) via a high voltage supply line (182), the idling and acceleration command box (116) via a wire harness (188), and the electric motor (120) via electric motor power lines (184) and the electric motor sensor wire harness (186). In some embodiments, the electric power activation, control, and distribution system may comprise an electric motor (120) electrically connected to the motor controller (118), and mechanically connected to the electric motor system shaft (138) via an electric motor coupling plate (136).

In some embodiments, the electric motor system shaft (138) is mechanically connected to the automatic transmission (200) via an automatic transmission coupling plate (206). In some embodiments, the electric motor system shaft (138) is rotatably suspended via a shaft bearing (202).

In some embodiments, the electric power activation, control, and distribution system may comprise alternators mounted on the vehicle frame. The first alternator (152), the first alternator pulley (154), the second alternator (156), and the second alternator pulley (158) may be mechanically connected to a shaft (138) and a main shaft pulley (140) via a distribution belt (150) for rotatably powering the first alternator (152) and the second alternator (156). In some embodiments, the first alternator (152) and the second alternator (156) may be electrically connected to the fuse box (104) via a power supply line (174) as an initial power source. In some embodiments, the first alternator (152) and the second alternator (156) may be respectively connected to the first battery (122) and the first solenoid (106) and the second battery (124) and the second solenoid (108) to provide power to the first alternator (152) and the second alternator (156).

In the present invention, the electric power activation, control, and distribution system may comprise DC-DC charging systems. In some embodiments, the first DC-DC battery charger (252), the second DC-DC battery charger (254), the third DC-DC battery charger (256), and the fourth DC-DC battery charger (258) may be electrically connected to the second DC-DC battery charger power supply line (210). In some embodiments, the fifth DC-DC battery charger (262), the sixth DC-DC battery charger (264), the seventh DC-DC battery charger (266), and the eighth DC-DC battery charger (268) may be electrically connected to the first DC-DC battery charger power supply line (208). In some embodiments, all DC-DC battery chargers may be electrically connected to the same common ground connection (170).

In the present invention, the electric power activation, control, and distribution system may comprise a main battery or high-power battery system (240) that follows the following charging method or process. The first battery set (270) is not directly connected to any DC-DC battery charger and the next battery set (272) in series is directly connected to the second DC-DC battery charger (254) connected to the second power supply line (210). The next battery set (274) in series is not directly connected to any DC-DC battery charger and the next battery set (276) in series is directly connected to the eight DC-DC battery charger (268) connected to the first power supply line (208).

The next battery set (278) in series is not directly connected to a DC-DC battery charger, and the next battery set (280) in series is directly connected to the third DC-DC battery charger connected to the second power supply line (210). The next battery set (282) in series is not directly connected to any DC-DC battery charger, and the next battery set (284) in series is directly connected to the sixth DC-DC battery charger (264) connected to the first power supply line (208).

The next battery set (286) in series is not directly connected to any DC-DC battery charger, and the next battery set (288) in series is directly connected to the first DC-DC battery charger (252) connected to the second power supply line (210). The next battery set (290) in series is not directly connected to any DC-DC battery charger, and the next battery set (292) in series is directly connected to the seventh DC-DC battery charger (266) connected to the first power supply line (208).

The next battery set (294) in series is not directly connected to any DC-DC battery charger, and the next battery set (296) in series is directly connected to the fourth DC-DC battery charger (258) connected to the second power supply line (210). The next battery set (298) in series is not directly connected to any DC-DC battery charger, and the next battery set (300) in series is directly connected to the fifth DC-DC battery charger (262) connected to the first power supply line (208).

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A battery recharging device configured for efficient charging, the device comprising:
a. a plurality of battery charging components (400) configured to receive a current from one or more first external sources;
b. a plurality of battery cells (410) comprising a first subset of battery cells and a second subset of battery cells, wherein the plurality of battery charging components (400) are operatively coupled to the first subset;
wherein the first subset and the second subset are interstitially disposed in an array;
wherein each battery cell of the first subset is operatively coupled to one or more battery cells of the second subset such that every battery cell of the second subset is operatively coupled to at least one battery cell of the first subset;
wherein the plurality of battery charging components (400) are further configured to deliver the current to the first subset;
wherein each battery cell of the first subset is configured to distribute the current to the one or more battery cells of the second subset operatively coupled to the battery cell of the first subset, such that the current is evenly distributed throughout the plurality of battery cells (410); and
c. one or more voltage supply lines (420) operatively coupled to at least one of the plurality of battery charging components (400), at least one of the plurality of battery cells (410), or a combination thereof, configured to deliver the current from the at least one of the plurality of battery charging components (400), the at least one of the plurality of battery cells (410), or the combination thereof to an electric motor (120).

2. The device of claim 1, wherein the one or more first external sources comprise one or more batteries, one or more alternators, a solar panel (220), a charging station (230), or a combination thereof.

3. An electric power control system for efficient charging of batteries, the system comprising:
a. one or more main batteries each main battery configured to accept, store, and transmit a current;
b. a rotating component configured to generate rotational motion;
c. one or more alternators operatively coupled to the first and second batteries and the rotating component, configured to accept the rotational motion from the rotating component, generate the current, and direct the current to the first and second batteries; and
d. a battery recharging device operatively coupled to the one or more main batteries, configured for efficient charging, the battery recharging device comprising:
i. a plurality of battery charging components (400) configured to receive the current from the first and second batteries;
ii. a plurality of battery cells (410) comprising a first subset of battery cells and a second subset of battery cells, wherein the plurality of battery charging components (400) are operatively coupled to the first subset;
wherein the first subset and the second subset are interstitially disposed in an array;
wherein each battery cell of the first subset is operatively coupled to one or more battery cells of the second subset such that every battery cell of the second subset is operatively coupled to at least one battery cell of the first subset;
wherein the plurality of battery charging components (400) are further configured to deliver the current to the first subset;
wherein each battery cell of the first subset is configured to distribute the current to the one or more battery cells of the second subset operatively coupled to the battery cell of the first subset, such that the current is evenly distributed throughout the plurality of battery cells (410); and
iii. one or more voltage supply lines (420) operatively coupled to at least one of the plurality of battery charging components (400), at least one of the plurality of battery cells (410), or a combination thereof, configured to deliver the current from the at least one of the plurality of battery charging components (400), the at least one of the plurality of battery cells (410), or the combination thereof to an electric motor (120).

4. The system of claim 3, wherein the rotating component comprises the electric motor (120).

5. The system of claim 4, wherein the electric motor (120) is configured to be powered by the one or more main batteries.

6. The system of claim 5, wherein the one or more main batteries are configured to distribute the current to the electric motor (120), the plurality of battery charging components (400), or a combination thereof by a fuse box (104).

7. The system of claim 6 further comprising one or more solenoids disposed electrically in-line with the fuse box (104) and the electric motor (120), configured to convert the current into rotational energy to actuate the electric motor (120).

8. The system of claim 4, wherein the electric motor (120) is further configured to operate an automatic transmission component (200) configured to convert the rotational motion of the electric motor (120) into movement.

9. The system of claim 4, wherein the rotating component is configured to transfer the rotational motion to the one or more alternators by a distribution belt (150).

10. The system of claim 3, wherein the system is configured to be integrated into an electric vehicle.

11. The system of claim 3, wherein the one or more main batteries are further configured to be charged by a solar panel (220), a charging station (230), or a combination thereof.

12. A charging system for an electric vehicle comprising:
a. one or more main batteries each main battery configured to accept, store, and transmit a current upon actuation;
b. a fuse box (104) operatively coupled to the first and second batteries, configured to distribute the current from the first and second batteries;
c. a system switch component (100), configured to accept a key (102) and actuate the one or more main batteries upon accepting the key (102);
d. an electric motor (120) operatively coupled to the fuse box (104) and the main battery (240), configured to generate rotational motion upon receiving the current from the fuse box (104) and the main battery (240);
e. an automatic transmission component (200) operatively coupled to the electric motor (120), configured to convert the rotational motion of the electric motor (120) into movement of the electric vehicle;
f. an acceleration pedal (110) operatively coupled to the electric motor (120), configured to control an amount of the rotational motion converted by the automatic transmission component (200) into the movement of the electric vehicle;
g. one or more alternators operatively coupled to the first and second batteries and the electric motor (120), configured to accept the rotational motion from the rotating component by a distribution belt (150), generate the current, and direct the current to the first and second batteries; and
h. a battery recharging device operatively coupled to the one or more main batteries, configured for efficient charging, the battery recharging device comprising:
i. a plurality of battery charging components (400) configured to receive the current from the first and second batteries;
ii. a plurality of battery cells (410) comprising a first subset of battery cells and a second subset of battery cells, wherein the plurality of battery charging components (400) are operatively coupled to the first subset;
wherein the first subset and the second subset are interstitially disposed in an array;
wherein each battery cell of the first subset is operatively coupled to one or more battery cells of the second subset such that every battery cell of the second subset is operatively coupled to at least one battery cell of the first subset;
wherein the plurality of battery charging components (400) are further configured to deliver the current to the first subset;
wherein each battery cell of the first subset is configured to distribute the current to the one or more battery cells of the second subset operatively coupled to the battery cell of the first subset, such that the current is evenly distributed throughout the plurality of battery cells (410); and
iii. one or more voltage supply lines (420) operatively coupled to at least one of the plurality of battery charging components (400), at least one of the plurality of battery cells (410), or a combination thereof, configured to deliver the current from the at least one of the plurality of battery charging components (400), the at least one of the plurality of battery cells (410), or the combination thereof to the electric motor (120).

13. The system of claim 12, wherein the one or more main batteries are further configured to be charged by a solar panel (220), a charging station (230), or a combination thereof.

14. The system of claim 12 further comprising an idling and acceleration controller box (116) operatively coupled to the acceleration pedal (110) and the electric motor (120), configured to convert a pressure applied to the acceleration pedal (110) into a signal.

15. The system of claim 14 further comprising a motor controller box (118) operatively coupled to the electric motor (120) and the idling and acceleration controller box (116), configured to operate the electric motor (120) based on the signal.

16. The system of claim 12, wherein the electric motor (120) is operatively coupled to the automatic transmission component (200) by a shaft component (138).

17. The system of claim 16, wherein the shaft component (138) is operatively coupled to the electric motor (120) by a shaft coupling plate (136).
